(19) United States
(12) Patent Application Publication
(10) Pub. No.: US 2017/0265139 A1
(43) Pub. Date: Sep. 14, 2017

(54) Apparatus And Method For A Task And Energy Efficient Black Box.

(71) Applicant: Daniel Minoli, Red Bank, NJ (US)

(72) Inventor: Daniel Minoli, Red Bank, NJ (US)

(21) Appl. No.: 15/065,112

(22) Filed: Mar. 9, 2016

(51) Int. Cl. H04W 52/02; H04W 40/24; B64D 45/00; H04H 20/16

(52) U.S. Cl. CPC H04W 52/0241; H04W 52/0283; H04H 20/16; H04W 40/244; B64D 45/00; B64D 2045/0065

(57) ABSTRACT

An apparatus and method for a task and energy efficient Black Box (BB) are disclosed. The various embodiments of the disclosure enable, support and/or provide a configuration paradigm enabling an energy limited device or “BB” to achieve optimal energy usage and the communication transmission scheme used. In the “deployed mode”, rather than wasting precious energy broadcasting a signal when no one can receive such energy, the unit operates in a stand-by dormant mode, managing its resources at a low level of energy consumption. In this mode, the unit simply listens to an activation signal coming from an “interrogator” transponder hat has actually deployed in the vicinity (within range). When the device detects an activation signal, it becomes “awaken” and it will then start broadcasting its ping.

### CROSS REFERENCE TO RELATED APPLICATIONS

This application claims the benefit to U.S. Provisional Application No. 62/125,136, filed on Mar. 10, 2015, and U.S. Provisional Application No. 62/239,133, filed on Oct. 8, 2015, which applications are incorporated herein by reference as if set forth in its entireties.

### FIELD OF THE INVENTION

The invention relates generally to “black boxes” associated with aeronautical platform, or to other detachable data acquisition systems, energy-limited devices that need to be physically located after a “deployed” (post-accident/post-separation) phase is entered and, more specifically, to optimal energy and communication transmission in order to maximize the operational utility of the energy-limited device.

### BACKGROUND

Generally, modern aircrafts currently operated by the commercial airline industry employ airborne data acquisition (ADA) equipment, such as a digital flight data acquisition unit (DFDAU), which monitors and stores signals supplied from a variety of transducers distributed throughout the aircraft, and provide digital data representative of the aircraft's flight performance based upon such transducer inputs. As flight performance data is obtained by the acquisition equipment, the data is stored in an attendant, physically robust flight data recorder (commonly known as the aircraft's “black box”—“BB”), such that in the event of an inflight mishap or other anomalies, the flight data recorder can be removed and the stored flight performance data analyzed to thereby determine the cause of the anomaly.

### SUMMARY

Various deficiencies of the prior art are addressed by a method and apparatus for a task and energy efficient Black Box (BB). One embodiment comprises an apparatus for use in maximizing the operational utility of an energy limited device. The apparatus comprises a computing architecture having a main module, an interface means, a communication means, wherein the computing architecture is configured to communicate with a remote apparatus. The apparatus further comprises a plurality of I/O (Input/Output) components communicatively coupled to said computing architecture; a memory having stored thereon instructions that upon execution by the main module cause the main module to transition from an initial state to an operational state to thereby propagate toward the remote apparatus data associated with the energy limited device; said interface means providing interaction with external and internal peripheral devices; and said communication means providing access to one or more networks, wherein the computing architecture achieves optimal energy usage for the energy limited device and the communication transmission scheme used.

Another embodiment comprises a method for maximizing the operational utility of an energy limited device. The method recites the steps of determining a state of the energy limited device; listening for an external signaling information to transition from an initial state to an operational state; broadcasting the energy limited device ping signaling data upon detection of said external signaling information; and modulating the utilization of power and transmission scheme to achieve optimal energy usage for the energy limited device and the communication transmission scheme used.

### BRIEF DESCRIPTION OF THE DRAWINGS

The teachings of the present invention can be readily understood by considering the following detailed description in conjunction with the accompanying drawings, in which:

FIG. 1 depicts an exemplary Block Diagram of the Next Generation Black Box (NGBB) according to an embodiment;

FIG. 2 depicts an illustrative Advanced Capabilities NGBB Block Diagram according to an embodiment;

FIG. 3 depicts an exemplary algorithm of the operation of NGBB as a function of time according to an embodiment;

FIG. 4 depicts an exemplary modulation algorithm of the Policy Manager Functional Module according to an embodiment; and

FIG. 5 depicts an exemplary modular functional capabilities algorithm according to an embodiment.

To facilitate understanding, identical reference numerals have been used, where possible, to designate identical elements that are common to the Figures.

### DETAILED DESCRIPTION

The invention will be primarily described within the context of particular embodiments; however, those skilled in the art and informed by the teachings herein will realize that the invention is also applicable to other technical areas and/or embodiments.

The illustrative apparatus and method embodiments described herein are not meant to be limiting. It may be readily understood that certain aspects of the disclosed apparatus and method can be arranged and combined in a variety of different configurations, all of which are contemplated herein.

Generally speaking, the various embodiments enable, support and/or provide a configuration paradigm enabling an energy limited device to achieve optimal energy usage and the communication transmission scheme used. A BB is a data recorder for flight or other voyage (an ADA, voyage recorders or BB for ships and the like), that allows stored information, be such information parameters, data points, coded voice, coded video, or other signals, to be extracted and analyzed once the BB device is physically retrieved following an event that has caused the BB to enter a “deployed” phase (typically a state of device “mis-location” in some harsh or otherwise “open” environment).

A BB typically comprises a power interface 105, airplane avionics or aircraft interface 106, Battery (B) 115, a Ping Generator (P) 117, and Transmit Antenna 120 such that when P is activated (e.g., by water immersion) it starts broadcasting a 37.5 Khz (or comparable) signal. The issue is that battery “B” only supports this function for time “T” (usually 30 days).

The signal has a range “R” in miles or kilometers. When activated, the BB will indiscriminately emit a signal, which will travel about one (1) mile in a watery medium, until its battery is exhausted.

One approach to improve the BB useful performance is to increase the battery operational life, say to 3T, but this may require more physical battery volume, or new chemical processes. Even then, the approach is not elegant, in the sense that the box “keeps talking even though there may be nobody within range “R,” to receive/hear the ping”. This goes to the old saying “If a tree falls in a forest and no one is around to hear it, does it make a sound?” Such construct is a philosophical thought experiment that raises questions regarding observation and knowledge of reality. Philosopher George Berkeley, in his work, “A Treatise Concerning the Principles of Human Knowledge (1710),” proposes, “But, say you, surely there is nothing easier than for me to imagine trees, for instance, in a park [ . . . ] and nobody by to perceive them. [ . . . ] The objects of sense exist only when they are perceived; the trees therefore, are in the garden [ . . . ] no longer than while there is somebody by to perceive them.”

As an analogy, should one find oneself buried under the debris caused by an earthquake for several days, should one start to continuously bang on a pipe using up precious physical energy, all the way to a point of exhaustion and fade-out, continuous banging alert or should one listen to establish if there are rescue people in the vicinity, and then start banging on the pipe, perhaps even with higher “average” power than would have been the case under other circumstances.

Thus, a BB should not waste its energy issuing a ping, unless there is someone there ready to listen/receive. This disclosure provides an intelligent BB that addresses this issue and enhances the current BB to a next-gen BB (NGBB), namely a BB that operates in a dynamically-based modality, especially regarding scarce-power management and transmission disciplines.

This present disclosure adds a number of intelligent (control) functional modules to the BB to achieve the embodiments of a NGBB.

It will be appreciated that functions depicted and described herein may be implemented in software and/or hardware, e.g., using a general purpose computer, one or more application specific integrated circuits (ASIC), and/or any other hardware equivalents.

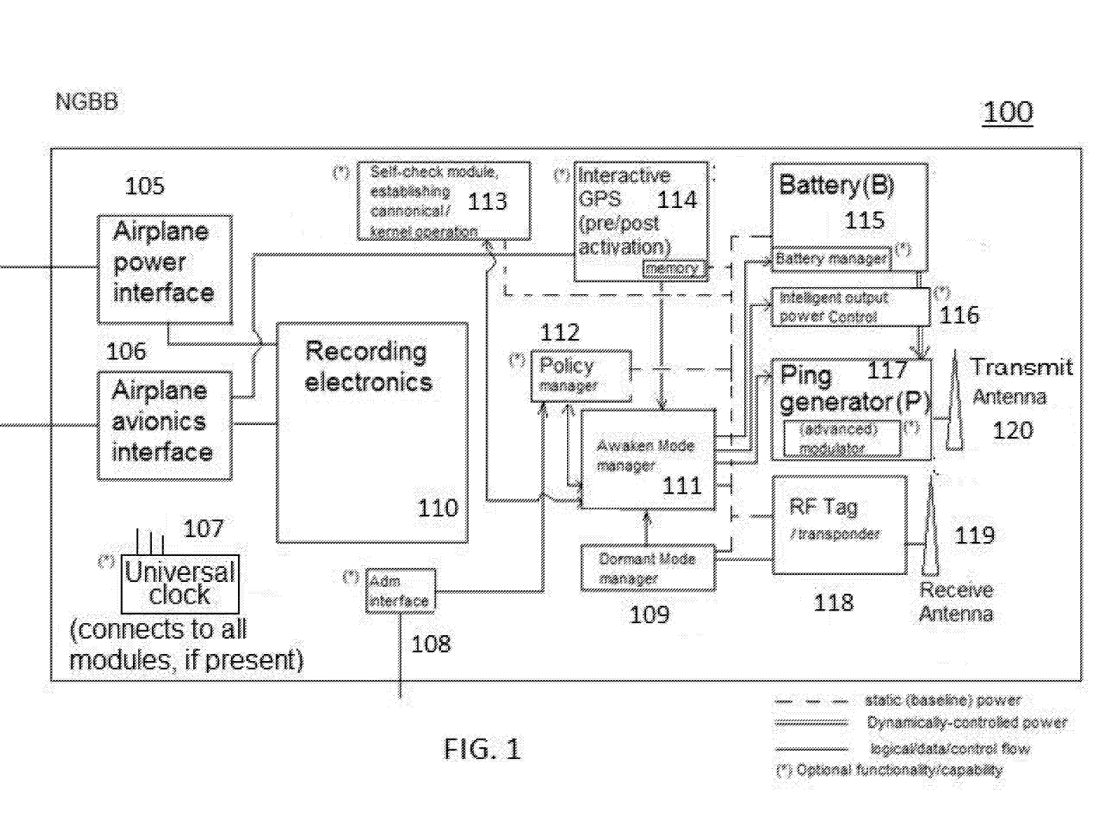

FIG. 1 depicts an exemplary Block Diagram of the Next Generation Black Box (NGBB) according to an embodiment. As depicted in FIG. 1, the architecture 100 of the energy limited devices adds to a classical BB a number of function-specific modules namely, an RF Tag/transponder Functional Module (RFTFM) 118, a Dormant Mode Manager Functional Module (DMMFM) 109, and an Awaken-mode Manager Functional Module (AMMFM) 111. This embodiment of the disclosure is called here the “Baseline NGBB, sans kernel” (BNSK).

The basic operation of the Baseline NGBB is as follows. Once in the “deployed mode”, rather than wasting precious energy broadcasting a signal when no one is around to receive such energy, the unit operates in a stand-by dormant mode, managing its resources at a low level of energy consumption (in the “Feature-enhanced NGBB” the administrator can pre-set what percentage of the battery life can be allocated to this task during the deployed-mode phase). The unit simply listens to an activation signal coming from an “interrogator” transponder 118, 119 that has actually deployed in the vicinity (within range). When the NGBB detects an activation signal, it becomes “awaken” and it will then start broadcasting its ping. (In the “Feature-enhanced NGBB” the ping cycle may follow a set of policies as to how long it is broadcast in case that another activating signal is not received within a specified time, or the amount of power being issued by the radio transmitter, or if more advanced noise-managing modulation schemes should be used, or if a GPS value of the NGBB's last known location is modulated over the ping signal. For example, Spread Spectrum mechanism could be applied.

In one embodiment, Dormant Mode Manager Functional Module (DMMFM) 109, which is a logical decision entity of much computational complexity manages the NGBB operation post-deployment and prior to entering the awaken mode. In one embodiment, the DMMFM incorporates a real-time, multi-tasking computing entity, which executes host functions, middleware suite and operational utility host suite for the maximization and optimization of operational utility of the limited energy device. Dormant Mode Manager 109 takes input from the RF Tag/transponder Functional Module (RFTFM) 118 and, upon establishing that a “legal” awake signal handshake has been received it passes control over to the Awaken-mode Manager Functional Module (AMMFM) 111. While in the dormant state, RF Tag/transponder Functional Module (RFTFM) 118, under the control of the Dormant Mode Manager Functional Module (DMMFM) 109, is able to accept an external activation signal and thus unable the NGBB to enter an awaken mode and start transmitting a ping signal according to a set of policies. The RFTFM employs a Receiver Antenna Module (RAM) 119 to receive the external activation signal. Some minimal-operation function can be incorporated into the NGBB if it is determined that receive antenna is damaged. In other embodiments, any computing device performs the functions of DMMFM.

Awaken-mode Manager Functional Module (AMMFM) 111 will select an appropriate set/sequence of ping-transmission policy(ies). Awaken-mode Manager 111 will continue to transmit these pings either as long as a “keep alive signal” from the remote external interrogator/transponder is received and/or a new transmit policy is implemented. If the keep-alive signal is not received for a specified (but administratively-selectable) time “t”, the AMMFM returns control to the DMMFM and the ping transmission activity is halted. To prevent the “accidental” awakening by some “non-useful” external device, a certain “2-way” handshake protocol could be used (I, interrogator, send you this specific sequence, you reply with another specific sequence, then I confirm), or if the concern is that he protocol complicates the operation (and thus might decrease reliability), a time-out mechanism could be used by the NGBB so that if it does not receive additional instances of the “keep-alive” interrogator signal, it will go back to the dormant mode. A certain canonical operation could be assumed in case that the NGBB is damaged and that a nominal/canonical operation is generally present in a kernel-based functionality. This capability is managed by the “self-check” functional module.

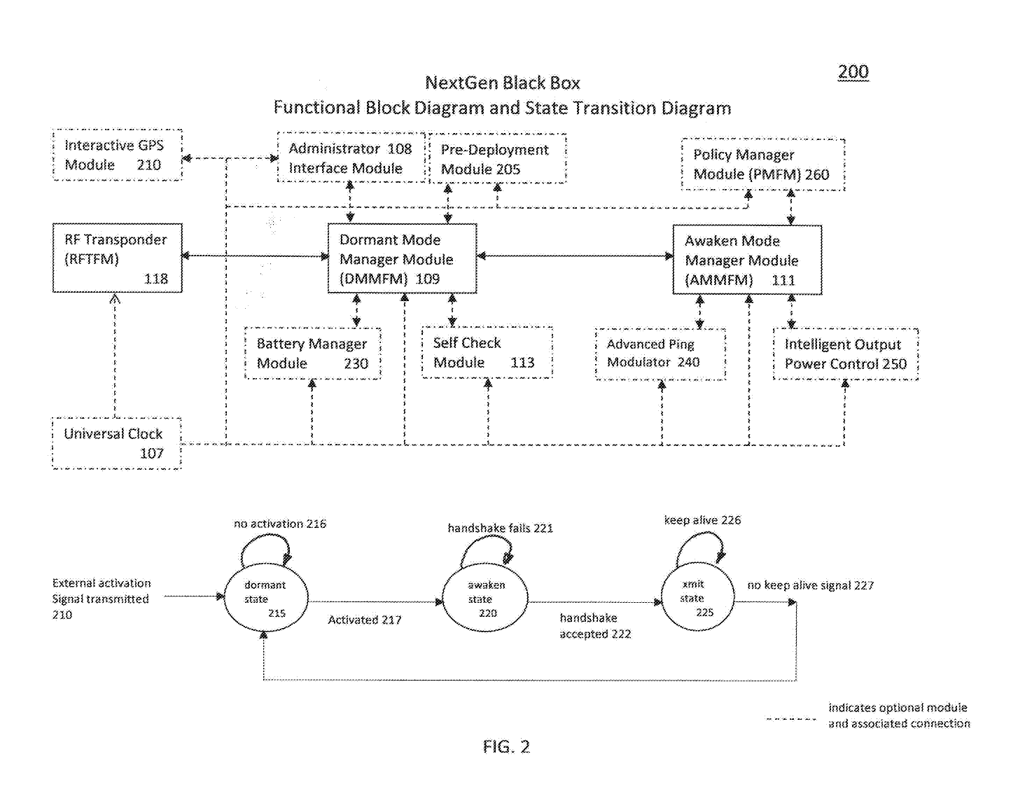

In another embodiment, Dormant Mode Manager 109 also interacts in the pre-deployment phase of NGBB as described below in reference to FIG. 2. Administrator Interface Functional Module (AIFM) 108 is employed to specify—in the pre-deployment mode—various operational parameters, policies, scripts, modalities, pre-programmed plan as instructed by the operator of the NGBB. In another embodiment, a one-time pre-configured set of operational policies is “burnt” into the device. In yet another embodiment, the pre-programmed plan includes a flight plan. With this invention, the NGBB can additionally incorporate more advanced capabilities.

FIG. 2 depicts an illustrative Advanced Capabilities NGBB Block Diagram according to an embodiment. As depicted in FIG. 2, the limited energy device namely, NGBB has a flexible architecture that can be tailored to incorporate different embodiments encompassing the following: Pre-Deployment Module 205, Interactive GPS Module 114, Battery Manager Module 230, Advanced Ping Modulator 240, Intelligent Output Power Control Module 250, Policy Manager Functional Module (PMFM) 260, Universal Clock 107, Self-check Module 113, and External Interrogator/Transponder 118. This embodiment of the invention is called a “Feature-enhanced NGBB” (FEN).

In one embodiment, NGBB operates in the pre-deployment mode via Pre-Deployment Module 205 collecting information such as parameters, data points, coded voice, coded video, location coordinates or other signals. Pre-Deployment Module 205 interfaces with the airborne data acquisition (ADA) equipment, such as a digital flight data acquisition unit (DFDAU), which monitors and stores signals supplied from a variety of transducers distributed throughout the aircraft. and provides digital data representative of the aircraft's flight performance based upon transducer inputs distributed throughout the aircraft. As flight performance data is obtained by the acquisition equipment, it is stored in an attendant, physically, robust, flight data recorder, such that in the unlikely event of an in-flight mishap, the flight data recorder can be removed and the stored flight performance data analyzed to determine the cause of the anomaly. Pre-Deployment Module 205 manages the interface to the ADA.

Interactive GPS Module 210 provides GPS capability, which may be implemented such that either the last location (as received over the avionics channel) or a location determined post-deployment under the control of the self-check module 113 is recorded, and then used by the Awaken Mode Manager to over-modulate such info over the ping channel by some appropriate and reliable digital modulation scheme (e.g., FSK, ASK, PHK, QAM, etc.). GPS (Global Positioning Satellite) works by GPS receivers using a constellation of satellites and ground stations to compute position and time almost anywhere on earth, There are ground based stations that communicate with the satellite network and are called the control segment. Common systems that are used by the control segment are WAAS (Wide Area Augmentation System) and DGPS (Differential Global Positioning Satellite). WAAS is the most common system and improves accuracy to about 5 meters. On the other hand, DGPS gets centimeter accuracy but is more expensive. GPS data is displayed in different message formats and the type of data that is outputted is NMEA (National Marine Electronics Association) data. Other accessible networks include GSM/GPRS. GPRS (Global Packet Radio Service) works by using the idle radio capacity created by the (Global System for Mobile Communications) GSM cellular network, which is the capacity of a network provider that is not being used. A GPRS module sends data transmission through data packets through multiple paths across a GSM network. The texting and calling function of device 100 works through the GSM cellular network and is controlled by AT commands. Those AT commands is the data transmission that GPRS module sends. In one embodiment, the GPS portion of device 100 can track up to 22 satellites on 66 channels. An external UFL antenna 119 is connected to the GPS module.

In another embodiment, Interactive GPS Module 210 implements an ancillary geographic positioning methodology (for example a GPS that either has the last pre-deployment location coordinates or has real-time location coordinates), and whose data can be encode and/or modulated by the awaken-mode manager to overlay said information onto the ping signal stream.

Battery Manager Functional Module (BMFM) 230 supports a power consumption allocation to various NGBB modalities. For example, expandable power “p1” to the dormant mode operation, expandable power “p2” to the awaken mode operation, expandable power “p3” to the awaken mode operation under policy “a” and expandable power p4 to the awaken mode operation under policy “b.”

Advanced Ping Modulator 240 implements the specific subset of possible ping-transmission modes as achievable by the survived modular capabilities, such modes also possibly entailing transmission power levels and/or advanced modulation schemes. Said modes may be a constrained subset of possible disciplines as listed in pre-deployment by an administrator using an administrative interface functional module (or comparable means), a subset which may also have been mission-dependent. In another embodiment, Advanced Ping Modulator 240 selects one or more ping-transmission modes from a plurality of possible algorithmic modes, said algorithms defining the transmission functionality available for use by the awaken-mode manager. Additionally, Advanced Ping Modulator 240 can overlay status or coordinate information onto the ping stream and/or can change the modulation of the signal from baseband (simple pulses) to a more sophisticated encoded signal that is more robust to noise and other environmental issues.

In other embodiments, Advanced Ping Modulator 240 incorporates the Advanced Modulator Functional Module (AMFM), which can be employed to alter the baseline modulation scheme and use some more resilient (or higher capacity) scheme (e.g., Frequency-shift keying (FSK), Amplitude-shift keying (ASK), Phase-shift keying (PHK), Quadrature amplitude modulation (QAM), etc.) if noise is detected in the transmission channel.

Intelligent Output Power Control/Controller Functional Module (IOPCFM) 250 operates under the control of the Awaken-mode Manager Functional Module (AMMFM). In another embodiment, the Awaken-mode Manager takes control from the Policy Manager Functional Module (PMFM)), and controls how much power is applied to the Ping Generator (P). This power may be increased based for example on a policy or if the received keep-alive signal is determined to be increasing over time (implying better proximity between the remote interrogator/transponder and the NGBB.) In other embodiments, the power management techniques used in Wireless Sensor Networks are used. The Internet of Things/RF1D/M2M approaches, concepts, techniques, technologies, and standards may also be relevant.

In other embodiments, Intelligent Output Power Control/Controller Functional Module (IOPCFM) 250 includes an ancillary intelligent output power control method that can be utilized by the awaken-mode manager to implement various pulse/ping/signal transmission schemes of specified power output, as defined by the policy manager.

Policy Manager Functional Module (PMFM) 260 supports the description of a plurality of possible signal-emission behaviors that can be selected and activated by the Awaken-mode Manager. Policy Manager Functional Module 260 defines the specific subset of possible ping-transmission modes as achievable by the survived modular capabilities, such modes also possibly entailing transmission power levels and/or advanced modulation schemes. Said modes may be a constrained subset of possible disciplines as listed pre-deployment by an administrator using an administrative interface functional module (or comparable means), a subset which may also have been mission-dependent. The policy manager may also define the length of time or time window a particular ping-transmission mode is used or the sequence of the various modes to be used over time.

Universal Clock Module 107 is used to maintain absolute time, so that the NGBB can establish how long it has been deployed, the time-of-day, etc. For example, a policy may specify that higher-power pings (power amplitude) are preferred during the daylight hours when investigators may be in the theater.

Self-check Module 113 allows the apparatus to determine which modular functional capabilities survived the deployment, thus enabling the apparatus to determine if transmission (pings) is performed in a “default/canonical/autonomous mode” minimizing the requirement that an awakening signal be received, or if it can operate in an “intelligent mode” that is activated when the awakening signal is received. In another embodiment, Self-check Module 113 is associated with an ancillary self-check functional method that allows the apparatus to implement such method to determine which modular functional capabilities survived the deployment. The awakening signal to be processed and assessed is an exact pre-defined/pre-established syntactic sequence, also possibly including a 2-way handshake. In other embodiments, the awakening signal to be processed and assessed is a signal in the electromagnetic spectrum, ranging from Extremely Low Frequencies to the Extremely High Frequency.

External Interrogator/Transponder 118 is used by the search vehicle. The transmit signal may be at some appropriate RF frequency (not necessarily the same as that of the ping transmissions.) Additionally, a 2-way handshake is implemented to ascertain that the activation signal is a well-established pattern, and not just some random signal. Additionally, a maintained keep-alive sequence prevents the NGBB from reverting back to a dormant state. In another embodiment, an L-band (or ku/ka band) TX/RX satellite link transceiver may be supported by the NGBB (especially if the NGBB happens to be deployed on land). In yet other embodiments, High Throughput Satellite (HTS) services are utilized.

External Interrogator/Transponder 118 enables the device (via the dormant-mode manager) to listen for an awakening signal from a (remote) interrogator transponder, and then to start broadcasting a ping according to various algorithms, after such awaken signal is received by the RF tag/transponder.

There are three (3) basic states associated with the operation of the NGBB namely, a dormant state 215, an awaken state 220 and a transmit state 225. The energy limited device remains in the dormant state 215 if no activation signal 216 is received. The unit simply listens to an activation signal coming from an “interrogator” transponder 118, 119 that has actually deployed in the vicinity (within range). When the NGBB detects an activation signal 210, it becomes “awaken” or activated 217. The unit then transitions to the awaken state. In this state, a 2-way handshake is implemented to ascertain that the activation signal is a well-established pattern, and not just some random signal. The unit transitions to transmit state if the handshake is accepted 222. A maintained keep-alive sequence 226 prevents the NGBB from reverting back to a dormant state 227.

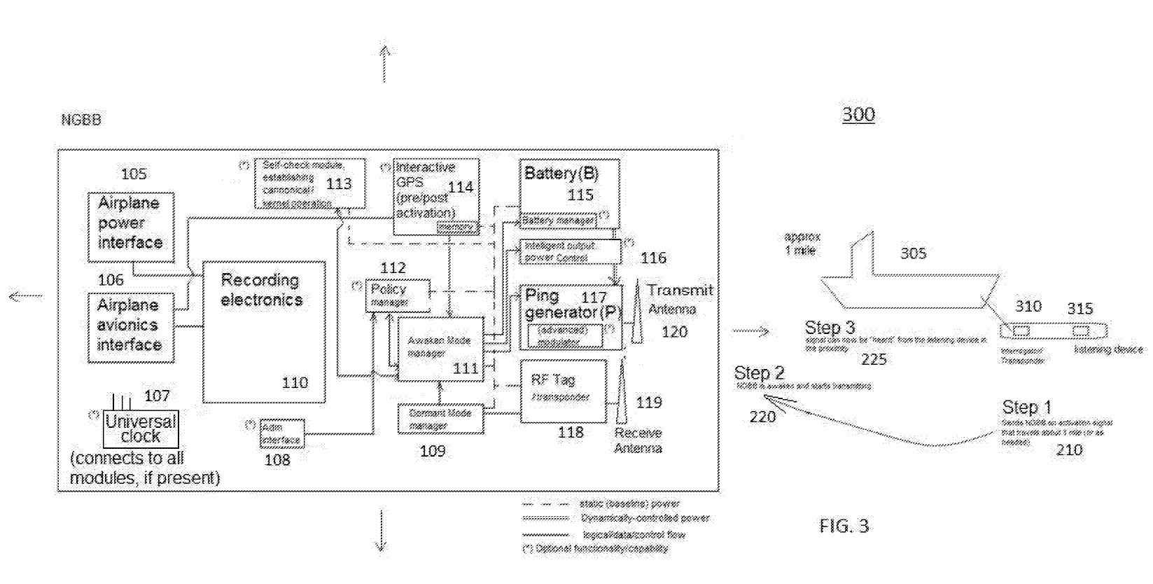

FIG. 3 depicts an exemplary algorithm of the operation of NGBB as a function of time according to an embodiment. As depicted in FIG. 3, in step 1, a search vehicle 305 equipped with an interrogator/transponder device 310 and a listening device 315 and located approximately within 1 mile of the energy limited device sends/transmits an activation signal toward the energy limited device. At step 2, the energy limited device is activated and starts transmitting. At step 3, the signal is received by the energy limited device, which transmits its ping according to the policy in place at the time.

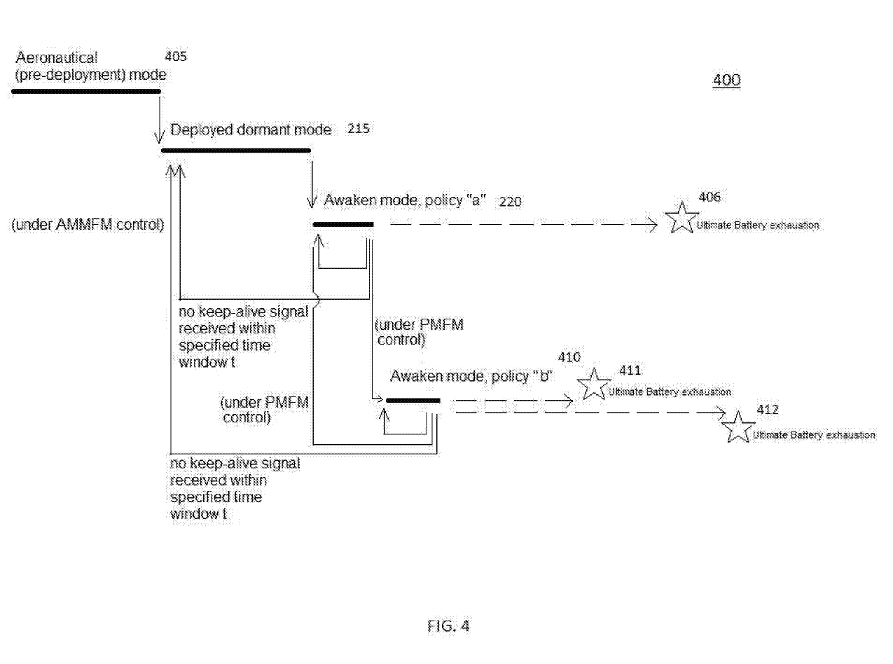

FIG. 4 depicts an exemplary modulation algorithm of the Policy Manager Functional Module according to an embodiment. At step 405, the device is in the pre-deployment mode under the Awaken Mode Manager Functional Module (AMMFM). In this embodiment, NGBB operates in the pre-deployment mode via Pre-Deployment Module 205 collecting information such as parameters, data points, coded voice, coded video, location coordinates or other signals. Pre-Deployment Module 205 interfaces with the airborne data acquisition (ADA) equipment, such as a digital flight data acquisition unit (DFDAU), which monitors and stores signals supplied from a variety of transducers distributed throughout the aircraft, and provides digital data representative of the aircraft's flight performance based upon transducer inputs distributed throughout the aircraft. After a mishap, at step 215 the device enters the “deployed dormant mode.” Rather than wasting precious energy broadcasting a signal when no one is around to receive such energy, the unit operates in a stand-by dormant mode, managing its resources at a low level of energy consumption (in the “Feature-enhanced NGBB” the administrator can pre-set what percentage of the battery life can be allocated to this task during the deployed-mode phase). The unit simply listens to an activation signal coming from an “interrogator” transponder 118, 119 that has actually deployed in the vicinity (within range). When the NGBB detects an activation signal, it becomes “awaken” and implements expandable power “p3” to the awaken mode operation under policy “a” 220 until ultimate battery exhaustion. In another embodiment; expandable power p4 operation under policy “b” 410 is implemented. Such policy is modulated to provide a battery life leading to ultimate battery exhaustion at 411 or a longer battery life leading to ultimate battery exhaustion at 412. In another embodiment; the environment may be such that Power Manager Functional Module returns to implementing expandable power “p3” under “policy a” at step 215 providing yet a different battery life leading to ultimate battery exhaustion at 406.

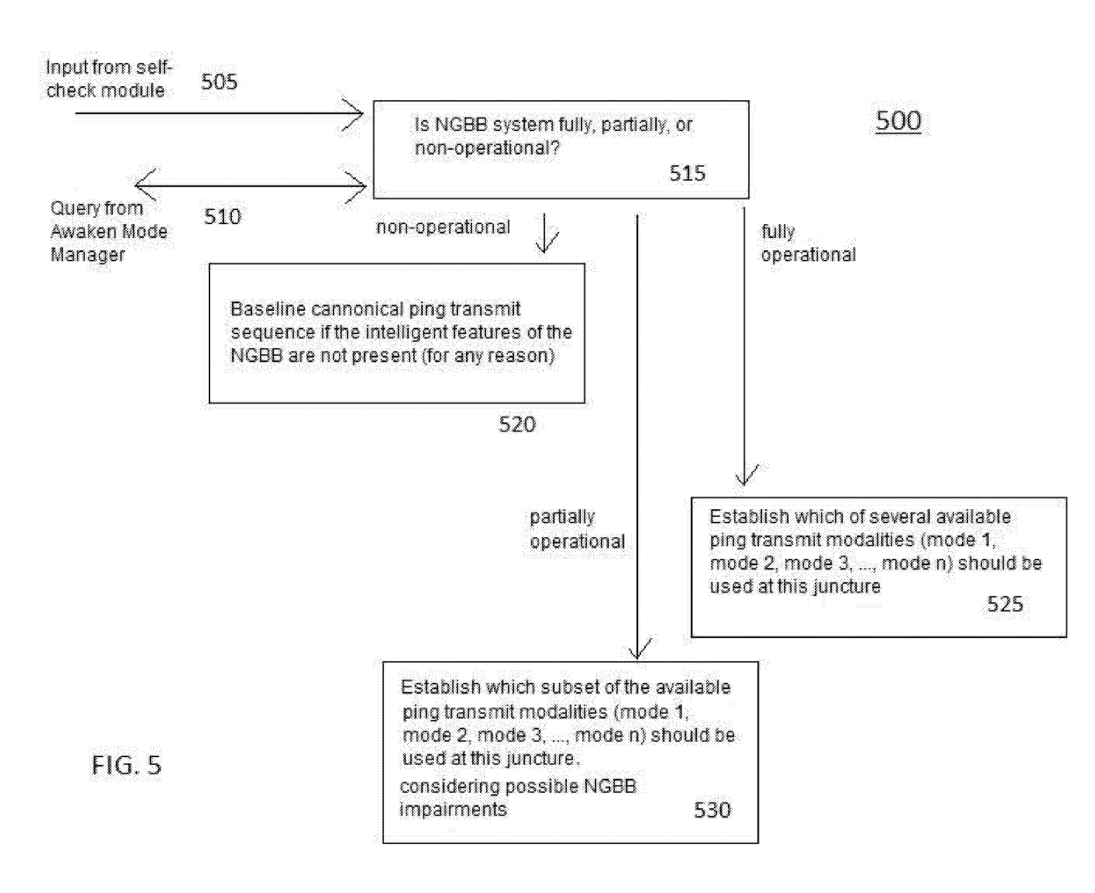

FIG. 5 depicts an exemplary modular functional capabilities algorithm according to an embodiment. At step 505, input from self-check module 113 is received. Referring to step 515, the operational state of the NGBB is determined namely, (1) non-operational; (2) fully operational: and (3) partially operational. At step 510, based on its query, the Awaken Mode Manager Functional Module is provided with the status of the NGBB. If non-operational, step 520 is executed. If fully operational, step 525 is executed. If partially operational, step 530 is executed.

Referring to step 520, the self-check module having determined the status of the NGBB after a deployment (of any kind) enforces a minimalistic canonical/kernel operation. A certain canonical operation is put in place in this case that the NGBB is damaged or non-operational and that a nominal/canonical operation is generally present in a kernel-based functionality.

Referring to step 525, a ping transmit modality is implemented. For example, one of mode 1, mode 2, mode 3 . . . mode n is implemented as listed in pre-deployment by an administrator using an administrative interface functional module (or comparable means).

Referring to step 530, Advanced Ping Modulator 240 implements the specific subset of possible ping-transmission modes as achievable by the survived modular capabilities, such modes also possibly entailing transmission power levels and/or advanced modulation schemes. Said modes may be a constrained subset of possible disciplines as listed in pre-deployment by an administrator using an administrative interface functional module (or comparable means), a subset which may also have been mission-dependent. In another embodiment, Advanced Ping Modulator 240 selects one or more ping-transmission modes from a plurality of possible algorithmic modes, said algorithms defining the transmission functionality available for use by the awaken-mode manager. Additionally, Advanced Ping Modulator 240 can overlay status or coordinate information onto the ping stream and/or can change the modulation of the signal from baseband (simple pulses) to a more sophisticated encoded signal that is more robust to noise and other environmental issues.

Although various embodiments which incorporate the teachings of the present disclosure have been shown and described in detail herein, those skilled in the art can readily devise many other varied embodiments that still incorporate these teachings.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, and/or stored within a memory within a computing device operating according to the instructions.

What is claimed is:

1. An apparatus for use in maximizing an operational utility of an energy limited device, comprising:
a computing architecture having a main module, an interface means, a communication means, said computing architecture configured to communicate with a remote apparatus;
a plurality of I/O components communicatively coupled to said computing architecture;
a memory having stored thereon instructions that upon execution by the main module cause the main module to transition from an initial state to an operational state to thereby propagate data associated with the energy limited device toward the remote apparatus;
said interface means providing interaction with external and internal peripheral devices; and
said communication means providing access to one or more networks,
wherein the computing architecture achieves optimal energy usage for the energy limited device and a communication transmission scheme used.

2. The apparatus of claim 1, wherein the main module comprises:
a processor adapted to perform a plurality of host functions using a middleware suite and an operational utility host suite;
the middleware suite enabling communications with one or more networks; and
the operational utility host suite enabling maximization of operational utility and optimization of the communication transmission scheme.

3. The computing architecture of claim 1, further comprising one or more function-specific modules.

4. The computing architecture of claim 3, wherein the one or more function-specific modules include an intelligent output power control module, a battery manager module, a policy manager module, an advanced ping modulator module, an administrator interface function module, a universal clock module.

5. The apparatus of claim 1, wherein an external signaling information triggers the computing architecture to transition from an initial state to an operational state.

6. The apparatus of claim 5, wherein said external signaling information originates from an interrogator transponder.

7. The apparatus of claim 6, wherein the limited energy device starts to broadcast its ping signaling data upon detection of said external signaling information.

8. The apparatus of claim 7, wherein continuous broadcasting of the ping signaling data is a function of policies corresponding to the operational state of the energy limited device.

9. The apparatus of claim 8, wherein said policies include a time window, power amplitude being issued by a radio transmitter, advanced noise-managing modulation scheme, GPS value of the last known location of the limited device.

10. The apparatus of claim 1, wherein data associated with the energy limited device transmits data associated with a pre-programmed plan.

11. The apparatus of claim 10, wherein the pre-programmed plan includes a flight plan.

12. The apparatus of claim 1, wherein the one or more networks include GPS, DGPS, WAAS, GPRS, GSM.

13. A method for maximizing an operational utility of an energy limited device, comprising:
determining a state of the energy limited device;
listening for an external signaling information to transition from an initial state to an operational state;
broadcasting the energy limited device ping signaling data upon detection of said external signaling information; and
modulating the utilization of power and transmission scheme to achieve optimal energy usage for the energy limited device and the communication transmission scheme used.

14. The method of claim 13, wherein continuous broadcasting of the ping signaling data is a function of policies corresponding to the operational state of the energy limited dev.

15. The method of claim 14, wherein said policies include a time window, power amplitude being issued by a radio transmitter, advanced noise-managing modulation scheme, GPS value of the limited device last known location.
